(19) United States
(12) Patent Application Publication
(10) Pub. No.: US 2020/0294339 A1
(43) Pub. Date: Sep. 17, 2020

(54) MULTI-FACTOR AUTHENTICATION FOR PHYSICAL ACCESS CONTROL

(71) Applicant: NEC Laboratories America, Inc., Princeton, NJ (US)

(72) Inventors: Kunal Rao, Monroe, NJ (US); Giuseppe Coviello, Princeton, NJ (US); Srimat Chakradhar, Manalapan, NJ (US); Min Feng, Monmouth Junction, NJ (US); Murugan Sankaradas, Dayton, NJ (US); Utsav Drolia, Milpitas, CA (US)

(21) Appl. No.: 16/809,147

(22) Filed: Mar. 4, 2020

Related U.S. Application Data
(60) Provisional application No. 62/816,472, filed on Mar. 11, 2019.

(51) Int. Cl. G07C 9/26; G06F 21/32; H04L 9/32; G06K 9/00

(52) U.S. Cl. CPC G07C 9/26; G06F 21/32; H04L 2463/082; G06K 9/00288; H04L 9/3231

(57) ABSTRACT

Methods and systems for authentication include determining, at a first worker system, that a master system that stores a current authentication-list cannot be reached by a first network. Authentication is performed on an authentication request using a previously stored copy of the authentication-list at the first worker system. The authentication includes facial recognition that is performed on detected face images for a first time window, before receiving the authentication request, and for a second time window, after receiving the authentication request. Authentication removes matching detected face images after completing an authentication request to prevent other individuals from using a same identifier. Access is granted to a secured area responsive to the authentication.

### RELATED APPLICATION INFORMATION

This application claims priority to U.S. Provisional Patent Application No. 62/816,472, filed on Mar. 11, 2019, incorporated herein by reference herein its entirety.

### BACKGROUND

### Technical Field

The present invention relates to authentication and, more particularly, to multi-factor authentication for physical access control.

### Description of the Related Art

Performing authentication of individuals in a large facility is challenging, particularly in contexts like stadiums, where there are areas where the general public is permitted and areas where only authorized personnel are permitted. Authentication may be needed in areas where network connectivity is limited or intermittent, and large numbers of people may need to be checked for access in real time.

### SUMMARY

A method for authentication includes determining, at a first worker system, that a master system that stores a current authentication-list cannot be reached by a first network. Authentication is performed on an authentication request using a previously stored copy of the authentication-list at the first worker system. The authentication includes facial recognition that is performed on detected face images for a first time window, before receiving the authentication request, and for a second time window, after receiving the authentication request. Authentication removes matching detected face images after completing an authentication request to prevent other individuals from using a same identifier. Access is granted to a secured area responsive to the authentication.

A method for authentication includes determining, at a first worker system, that a master system that stores a current authentication-list cannot be reached by a first network. A previously stored copy of the authentication-list is downloaded to the first worker system, from a second worker system, via a second network that is distinct from the first network, responsive to the determination that the master system cannot be reached. Multi-factor authentication is performed on an authentication request using a previously stored copy of the authentication-list at the first worker system. The authentication includes an identification scan, a schedule check for a recognized individual, and facial recognition that is performed on detected face images for a first time window, before receiving the authentication request, and for a second time window, after receiving the authentication request. Authentication removes matching detected face images after completing an authentication request to prevent other individuals from using a same identifier. Access is granted to a secured area responsive to the authentication. It is determined that the master system can be reached by the first network, after performing authentication. An up-to-date copy of the authentication-list is downloaded to the first worker system, from the master system, responsive to the determination that the master system can be reached. Authentication is repeated using the up-to-date copy of the authentication-list at the first worker system. An alert is issued, responsive to a determination that the repeated authentication has a different result from authentication performed using the previously stored copy of the authentication-list.

A system for authentication includes a first network interface, configured to communicate with a remote master system via a first network, and to determine when the remote master system is not accessible via the first network. An authenticator is configured to perform authentication on an authentication request using a previously stored copy of the authentication-list at the first worker system when the remote master system is not accessible via the first network. The authentication includes facial recognition that is performed on detected face images for a first time window, before receiving the authentication request, and for a second time window, after receiving the authentication request. Authentication removes matching detected face images after completing an authentication request to prevent other individuals from using a same identifier. An authentication console is configured to grant access to a secured area responsive to the authentication.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of an environment that includes a secured area and an unsecured area, with distributed multi-factor authentication being used to handle access to the secured area, in accordance with an embodiment of the present invention;

FIG. 2 is a block diagram of a distributed multi-factor authentication system that includes multiple worker systems in communication with a master system, where the communication network may be unreliable, in accordance with an embodiment of the present invention;

FIG. 3 is a block diagram of a master multi-factor authentication system in accordance with an embodiment of the present invention;

FIG. 4 is a block diagram of a worker multi-factor authentication system in accordance with an embodiment of the present invention;

FIG. 5 is a block/flow diagram of a method for performing distributed multi-factor authentication in accordance with an embodiment of the present invention; and

FIG. 6 is a block/flow diagram for a method of performing multi-factor authentication using out of date authentication-lists, in the context of an unreliable network, in accordance with an embodiment of the present invention; and

FIG. 7 is a block/flow diagram of a method for matching faces in particular time windows, in accordance with an embodiment of the present invention.

### DETAILED DESCRIPTION OF PREFERRED EMBODIMENTS

Embodiments of the present invention provide distributed streaming video analytics for real-time authentication of large numbers of people. For example, the present embodiments can access video feeds from cameras and perform face recognition, identification card data extraction, and schedule review to perform multi-factor authentication for individuals who are moving through a controlled access point, such as a door or gate. The present embodiments can include lists of individuals, both authorized and specifically non-authorized, and can provide alerts as people on such lists are recognized.

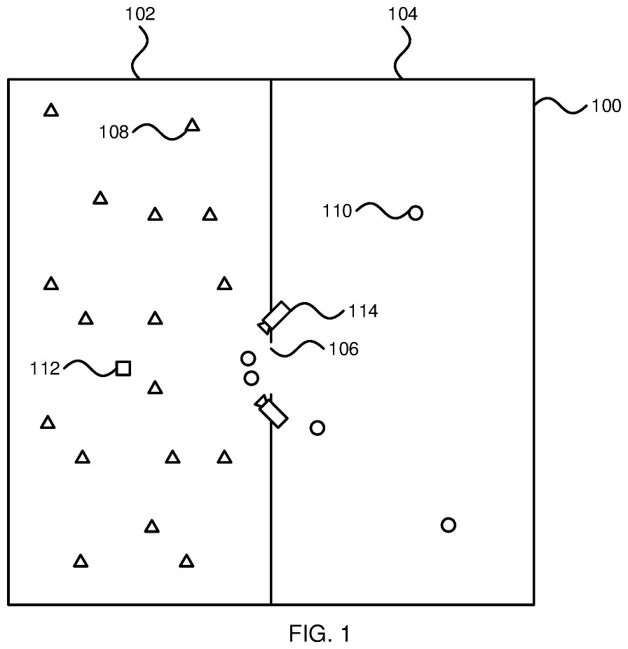

Referring now to FIG. 1, an exemplary monitored environment 100 is shown. The environment 100 shows two regions, including an uncontrolled region 102 and a controlled region 104. It should be understood that this simplified environment is shown solely for the sake of illustration, and that realistic environments may have many such regions, with differing levels of access control. For example, there may be multiple distinct controlled regions 104, each having different sets of authorized personnel with access to them. In some embodiments, regions may overlap.

A boundary is shown between the uncontrolled region 102 and the controlled region 104. The boundary can be any appropriate physical or virtual boundary. Examples of physical boundaries include walls and rope—anything that establishes a physical barrier to passage from one region to the other. Examples of virtual boundaries include a painted line and a designation within a map of the environment 100. Virtual boundaries do not establish a physical barrier to movement, but can nonetheless be used to identify regions with differing levels of control. A gate 106 is shown as a passageway through the boundary, where individuals are permitted to pass between the uncontrolled region 102 and the controlled region 104.

A number of individuals are shown, including unauthorized individuals 108, shown as triangles, and authorized individuals 110, shown as circles. Also shown is a banned individual 112, shown as a square. The unauthorized individuals 108 are permitted access to the uncontrolled region 102, but not to the controlled region 104. The authorized individuals are permitted access to both the uncontrolled region 102 and the controlled region 104. The banned individual 112 is not permitted access to either region.

The environment 100 is monitored by a number of video cameras 114. Although this embodiment shows the cameras 114 being positioned at the gate 106, it should be understood that such cameras can be positioned anywhere within the uncontrolled region 102 and the controlled region 104. The video cameras 114 capture live streaming video of the individuals in the environment, and particularly of those who attempt to enter the controlled region 104. Additional monitoring devices (not shown) can be used as well, for example to capture radio-frequency identification (RFID) information from badges that are worn by authorized individuals 108.

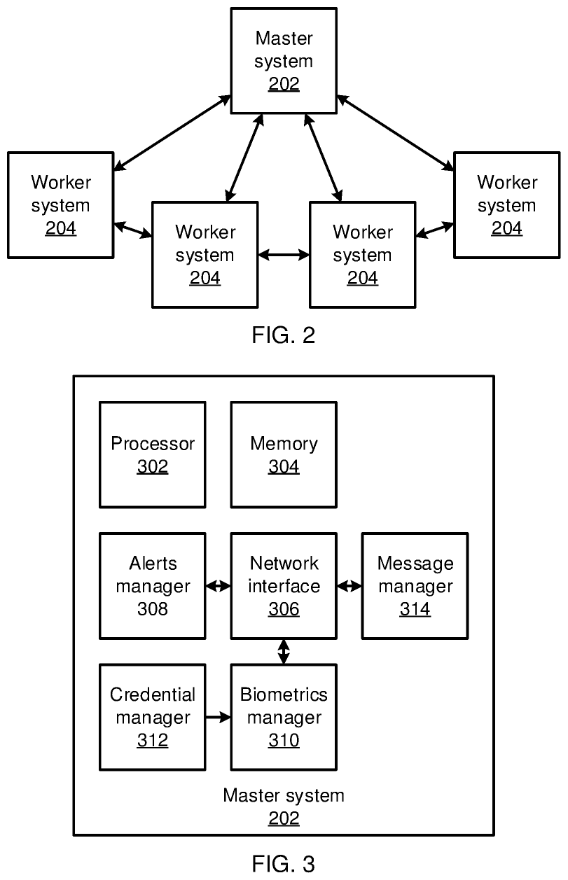

Referring now to FIG. 2, a diagram of a distributed authentication system is shown. A single master system 202 communicates with a number of worker systems 204. The master system 202 handles authentication-list management, alert management, and can optionally also handle third-party message management. Worker systems 204 are assigned to respective regions in the environment 100, or in some cases to particular gates 106, and locally handle multi-factor authentication and authentication-list checking. Depending on the computational resources of the worker systems 204, one or more video streams can be handled at each worker system 204. Multiple worker system 204 can be added to a single master system 202 to dynamically scale and include more locations for multi-factor authentication, without affecting existing live operation.

In general, for applications where there need only be a single instance across a site, such functions are implemented by the master system 202. In contrast, video collection, face detection, RFID detection, and other related tasks are performed by the individual worker systems 204.

In some embodiments, the worker systems 204 can be connected to the master system 202 by any appropriate network, for example a local area network. In other embodiments, the worker systems 204 can be connected to the master system 202 and to one another via a mesh network, where each system communicates wirelessly with one or more neighboring systems to create a communication chain from each worker system 204 to the master system 202. In some cases, where communication with the master system 202 is unreliable or intermittent, the worker systems 204 can communicate with one another to obtain credential information and authentication-lists. In some embodiments, the worker systems 204 can communicate with one another via a distinct network as compared to their communications with the master system. For example, worker systems 204 may be connected to one another via a wired local area network, whereas the master system 202 may be available through a wireless network, such as a cell network.

Referring now to FIG. 3, detail of an exemplary master system 202 is shown. The master system 202 includes a hardware processor 302 and a memory 304. A network interface 306 provides communications between the master system 202 and the worker systems 204. The network interface 306 can also provide communications with other systems, such as corporate databases that include credential information, as well as providing access to third-party information, including data streams, authentication-list information, and credential information. The network interface 306 can communicate using any appropriate wired or wireless communications medium and protocol.

An alerts manager 308 can, for example, use the network interface 306 to receive communications from the worker systems 202 relating to individual authentication results. For example, when a worker system 202 determines that an unauthorized individual 106 has entered a controlled region 104, the alert manager 308 can issue an alert to a supervisor or to security personnel. The alert manager 308 can also trigger one or more actions, such as sounding an alarm or automatically locking access to sensitive locations and material. The alerts manager 308 can furthermore store alerts from the worker system 202, including information relating to any local overrides at the worker system 202.

A biometrics manager 310 can manage authentication-lists, including lists of authorized individuals and banned individuals, and can furthermore maintain information relating to the people in those lists. For example, biometrics manager 310 can maintain a database for each individual in each list, to store details that may include an identification number/barcode, the individual's access privileges, the individual's work schedule, etc. The biometrics manager 310 can provide an interface that allows users to add, update, and remove individuals from authentication-lists, to turn on and off authentication for particular authentication-lists, to add, remove, and update authentication-lists themselves, to search for individuals using their names or images, and to merge records/entries when a particular individual has multiple such records.

The biometrics manager 310 can communicate with a credential manager 312. The credential manager 312 can interface with a corporate database, for example via local storage or via the network interface 306, to retrieve credential information for individuals, such as their identification number/barcode, an image of the individual, the individual's schedule, and the individual's access privileges. The credential manager 312 can, in some embodiments, be integrated with the biometrics manager 310, or can be implemented separately. In some embodiments, the credentials can be stored in a hash table.

A message manager 314 receives third-party information through the network interface 306. This third-party information can include third-party scan messages, which can be provided to other systems. For example, message manager 314 can provide an interface to third-party applications that makes it possible to perform authentication and issue alerts based on information that is collected by a third-party barcode reader or RFID reader.

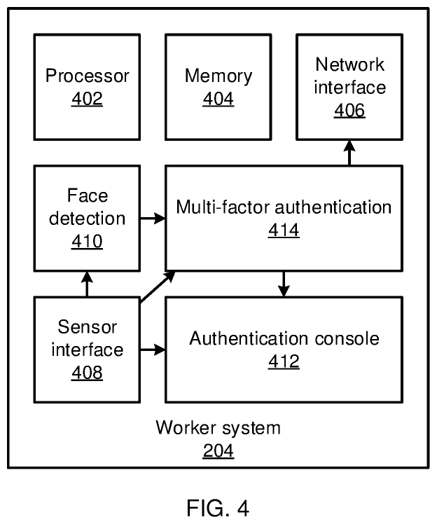

Referring now to FIG. 4, detail of an exemplary worker system 204 is shown. The worker system 204 includes a hardware processor 402 and a memory 404. A network interface 406 provides communications between the worker system 204 and the master system 202. The network interface 406 can also provide communications with one or more network-enabled data-gathering devices, such as networked security cameras. The network interface 406 can communicate using any appropriate wired or wireless communications medium and protocol.

A sensor interface 408 gathers information from one or more data-gathering devices. In some embodiments, these devices can connect directly to the sensor interface 408 to provide, e.g., a video stream, RFID tag scans, or barcode scans. In other embodiments, the data-gathering devices can be network-enabled, in which case the sensor interface 408 collects the information via the network interface 406. It should be understood that the sensor interface 408 can support connections to various types, makes, and models, of data-gathering devices, and may in practice represent multiple physical or logical components, each configured to interface with a particular kind of data-gathering device.

In embodiments where the sensor interface 408 receives information from one or more video cameras, the sensor interface 408 receives the camera feed(s) and outputs video frames. In embodiments where the sensor interface 408 receives information from an RFID device or a barcode scanner, the sensor interface 408 retrieves the scan message from the device, filters duplicate scans within a predetermined time interval, and outputs filtered scan messages.

Face detection 410 is performed on video frames from the sensor interface 408. Detected faces in the frames are provided to multi-factor authentication (MFA) 414. Face detection 410 can include filtering a region of interest within a received video frame, discarding unwanted portions of the frame, and generating a transformed frame that includes only the region of interest (e.g., a region with a face in it). Face detection 410 can furthermore perform face detection on the transformed frame either serially, or in parallel. In some embodiments, for example when processing video frames that include multiple regions, the different regions of interest can be processed serially, or in parallel, to identify faces.

MFA 414 retrieves detected faces and stores them for a predetermined time window. In addition, MFA 414 collects information from, e.g., scan messages (including third-party scan messages), and uses multiple factors of authentication to provide an authentication result. The multiple factors can include barcode matching, face matching and schedule matching.

In barcode matching, MFA 414 determines whether the scanned barcode or RFID identifier matches an individual's associated number in the database. In face matching, MFA 414 determines whether the face associated with the scanned barcode or RFID, matches with the detected faces in the video frames within a time window preceding and following the scan. In schedule matching, MFA 414 determines whether a person who has been identified using one of the other factors is expected to be entering a particular controlled area 104 at the time in question.

In one example, the MFA 414 may recognize the face of an authorized individual 108 approaching a gate 106. The MFA 414 may furthermore determine that the individual is carrying their badge, for example by scanning an RFID tag in the badge. However, upon checking the individual's schedule, the MFA 414 may determine that the individual is not scheduled to work on that day, and may deny access. In another example, if the MFA 414 determines that an authorized individual's badge is present, and that the individual is scheduled to work, but finds that the detected face does not match the stored image of the user, the MFA 414 may deny access. By using multiple authentication factors, MFA 414 prevents unauthorized accesses that might otherwise be overlooked.

MFA 414 can furthermore connect to the master system 202, and in particular biometrics manager 310, to obtain authentication-list information, including the above-mentioned details of the individuals in the authentication-lists. Because the network connection between the worker systems 204 and the master system 202 can be unreliable or intermittent, MFA 414 can keep track of how recently the authentication-list was updated and can provide a local alert through the authentication console 412 when the authentication-list is significantly out of date. The MFA 414 can furthermore communicate to the alerts manager 308 information regarding any denial or grant of access, including the reasons therefore, to trigger an appropriate alert. This information can be stored for audit purposes. If access was granted, then the stored information can include their identity and the time of access. If access was denied, then the stored information can include their identity, the time of denial, and the reason for denial. In the event that the determination of the MFA 414 is overridden by a supervisor, then information can also be stored regarding who performed the override, what the original result and the override result were, and the time.

Face detection 410 can store detected faces in memory 404. In some embodiments, the detected faces can be removed from memory 404 after the expiration of a predetermined time window. MFA 414 can similarly keep a face matching request for a predetermined time period. If no face is matched in that time, MFA 414 can delete the face matching request.

An authentication console 412 receives information from the sensor interface 408, for example collecting video frames. The authentication console 412 provides a user interface for security personnel, making it possible for such personnel to view the camera feeds, to view authentication results from MFA 414 (along with reasons for denial), to view schedule information for recognized individuals, to view the network connection status to the master system 202, to view the database freshness (e.g., the amount of time since the database was last updated), to search for particular credentials, to view and adjust the position of particular cameras/sensors, and to override determinations made by MFA 414.

The authentication console 412 can also manage notifications. These notifications can include instructions from the master system 202 to add, update, or remove particular authentication-lists, instructions which the authentication console 412 can perform responsive to receipt of the notifications. The notifications can also include local notifications, for example pertaining to whether the authentication-lists are freshly synchronized to the authentication-lists on the master system 202.

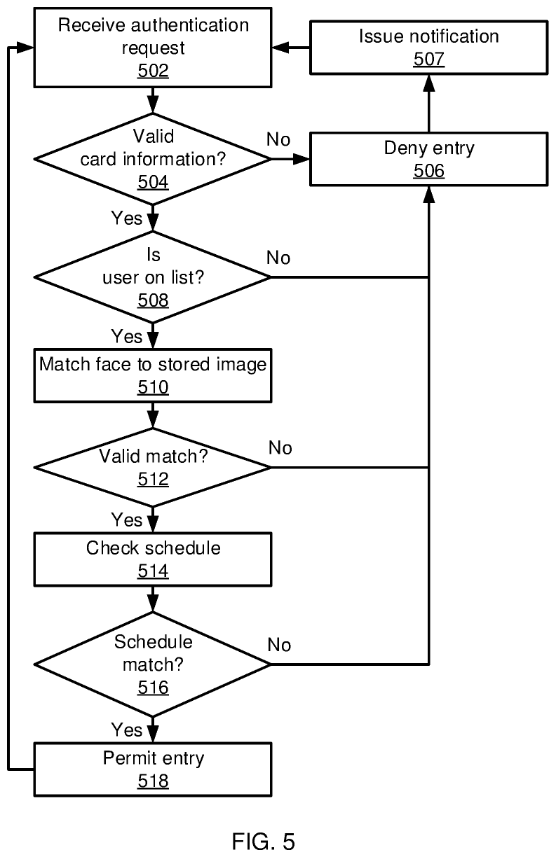

Referring now to FIG. 5, a method of performing MFA is shown. Block 502 receives an authentication request, for example upon receipt of a scan message from a user's barcode or RFID badge, or upon detection of an individual approaching a gate 106. Block 504 determines whether the individual's card information (e.g., an identifier stored in the barcode or RFID badge) is valid. This determination can include, for example, determining whether the individual has stored credentials at all. In some situations, the scan message may have an inaccurate or incomplete identifier. In other situations, the identifier may be from an old card, or one from a different site, such that the credentials are not stored. In any of these events, entry to the secured area 104 can be denied in block 506, and a notification can be issued in block 507 to the authentication console 412 to indicate that an unknown individual has attempted to gain access to the secured area 104.

If the individual's credentials are found, block 508 checks whether the individual is on one or more authentication-list for the secured area 104. For example, the authentication-list may indicate that the individual is one who is permitted access. If not, block 506 denies the individual entry. In some embodiments, block 508 can also check for membership to a list of individuals who are banned and denied entry, in which case membership on the list will cause processing to pass from block 508 to block 506.

If the individual is on the authentication-list, block 510 matches a detected face for the approaching individual, extracted from a video stream, to a stored image of the user. Block 512 then determines whether the face matches. In some events, the face may not match due to a low-quality image capture, while in other events, the two images may show different faces. In these events, block 506 denies entry, and block 507 can issue a notification to the authentication console 412 to indicate that the individual needs to pose for a better picture, or that there is a mismatch between the person who owns the card and the person who scanned the card.

Block 510 can operate within a defined time window. When an authentication request is received, all faces detected during a first time window (e.g., between 10 and 30 seconds) are matched to the stored image of the user. If a match is found, operation proceeds. If not, the authentication request can be repeated, for example every second, with the subsequently detected faces for a second time window (e.g., between 1 and 5 seconds). If no match has been found after the expiration of the second time window, the authentication request can be denied. The lengths of the time windows can vary, depending on the operational environment. In some embodiments, the denial can be delayed for a period of time to give the user an opportunity to change their pose for another attempt. In some embodiments, when a face is matched, all detected faces within the time window that match the matched face can be removed. This prevents another person from scanning the same card again, while the original user's face images are still stored for matching.

Block 514 then checks the schedule associated with the individual. The schedule can indicate, for example, whether the individual would plausibly have a need to enter the secured area 104 at the time in question. If the individual's schedule does not match the time of the scan message, then block 506 can deny entry, and block 507 can issue a notification to the authentication console 412 to indicate that the individual is not permitted access at the present time.

If all of these different checks are successful, then block 518 can permit entry. This can include communicating with authentication console 412 to indicate that the user has access to the secured area 104, and can further include actions such as unlocking a door or permitting access through a turnstile.

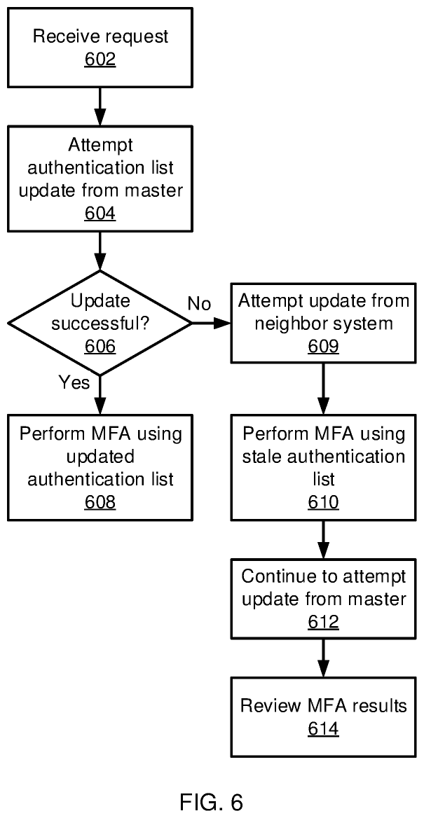

Referring now to FIG. 6, a method for obtaining updated authentication-lists is shown. It should be noted that the same process can be used to obtain credential information. Block 602 receives an authentication request for an individual at a worker system 204. The worker system 204 attempts to obtain the latest authentication-list information from the master system 202 by, for example, communicating over a wireless network, and block 606 checks whether the update was successful. Blocks 604 and 606 can further determine that no change has been made to the authentication-list since it was last downloaded, which can be treated as a successful update. If the update was successful, then the worker system 204 performs MFA in block 608 using the updated authentication-list. In some embodiments, updates to the authentication-list can be downloaded periodically, in addition to being prompted by an authentication request.

In some embodiments authentication-lists can be downloaded in batches. For example, if there are multiple different authentication-lists, then updates to all of the authentication-lists can be transmitted to the worker system 202 at the same time, thereby reducing the number of times that the worker system 202 has to communicate with the master system 204, and improving the overall freshness of the stored authentication-lists in the event that the connection is lost. The number of authentication-lists, and number of entries per authentication-list, that are updated in a single batch can be tuned to reflect the reliability of the network, so that a larger batch transfer is less likely to be interrupted.

If the update was not successful, the worker system 204 can, in some embodiments, attempt to obtain an updated authentication-list from a neighboring worker system. For example, if the master system 202 is down, or is not accessible due to a network fault, the worker systems 204 can share information to identify a most recent version of the authentication-list. Using the most recent available authentication-list, whether from a previously stored local version or a version at a neighboring system, block 610 performs MFA and allows or denies access to the individual. The authentication console 412 provides an alert at the worker system 204 to indicate that a stale authentication-list was used, so that a human operator can provide additional review if needed.

In some embodiments, block 610 can check to determine how old the most recent available authentication-list is. In the event that the most recent available authentication-list is older than a threshold value, then some embodiments can deny all authentication requests, until the authentication-list can be updated.

Block 612 continues to attempt updates from the master system 202. When a connection to the master system 202 is reestablished, an up-to-date authentication-list is downloaded. Block 614 can then review earlier authentication requests and can flag any denials or acceptances that were issued in error. For example, if an individual was allowed entry to a secured area 104 due to an out of date authentication-list, where the individual's access privileges had been removed, then the authentication console 412 can provide an alert.

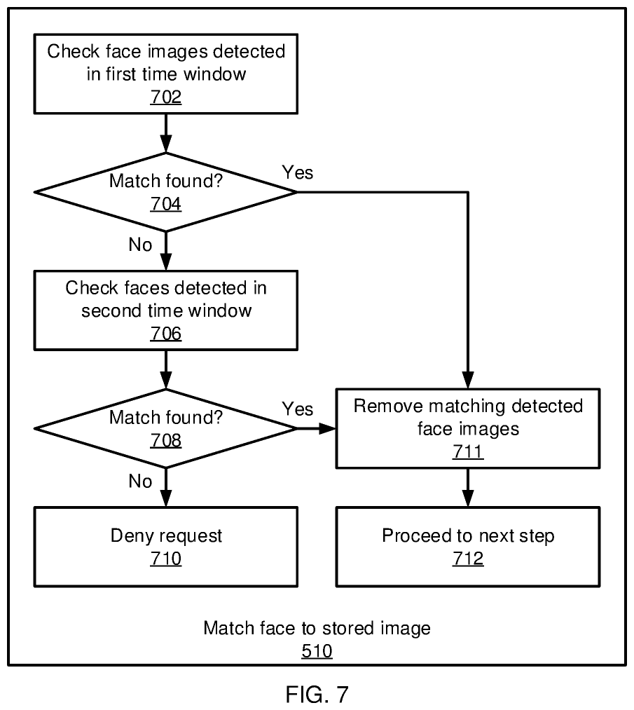

Referring now to FIG. 7, additional detail is shown on the face matching step 510. As noted above, face matching can operate within defined time windows. When an authentication request is received, all faces detected during a first time window (e.g., between 10 and 30 seconds) preceding the authentication request are matched by block 702 to one or more mapped and stored images of the user. If a match is found by block 704, matching face images are deleted in block 711 and operation proceeds at block 712. If not, the authentication request can be repeated, for example every second, with the subsequently detected faces for a second time window (e.g., between 1 and 5 seconds) following the authentication request in block 706. If no match has been found by block 708 after the expiration of the second time window, the authentication request can be denied by block 710. The lengths of the time windows can vary, depending on the operational environment.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for authentication, comprising:
determining, at a first worker system, that a master system that stores a current authentication-list cannot be reached by a first network;
performing authentication on an authentication request using a previously stored copy of the authentication-list at the first worker system, wherein the authentication includes facial recognition that is performed on detected face images for a first time window, before receiving the authentication request, and for a second time window, after receiving the authentication request, and wherein authentication removes matching detected face images after completing an authentication request to prevent other individuals from using a same identifier; and
granting access to a secured area responsive to the authentication.

2. The method of claim 1, further comprising downloading the previously stored copy of the authentication-list to the first worker system, from a second worker system.

3. The method of claim 2, wherein the first worker system and the second worker system are connected via a second network that is distinct from the first network.

4. The method of claim 3, wherein the second network is a mesh network.

5. The method of claim 1, wherein authentication comprises multiple factors, including an identification scan, facial recognition and a schedule check for a recognized individual.

6. The method of claim 5, wherein performing authentication further comprises authenticating the identification scan using a previously stored copy of credentials at the first worker system.

7. The method of claim 1, further comprising:
determining that the master system can be reached by the first network, after performing authentication; and
downloading an up-to-date copy of the authentication-list to the first worker system, from the master system.

8. The method of claim 7, further comprising repeating authentication using the up-to-date copy of the authentication-list at the first worker system.

9. The method of claim 8, further comprising issuing an alert responsive to a determination that the repeated authentication has a different result from authentication performed using the previously stored copy of the authentication-list.

10. A method for authentication, comprising:
determining, at a first worker system, that a master system that stores a current authentication-list cannot be reached by a first network;
downloading a previously stored copy of the authentication-list to the first worker system, from a second worker system, via a second network that is distinct from the first network, responsive to the determination that the master system cannot be reached;
performing multi-factor authentication on an authentication request using a previously stored copy of the authentication-list at the first worker system, wherein the authentication includes an identification scan, a schedule check for a recognized individual, and facial recognition that is performed on detected face images for a first time window, before receiving the authentication request, and for a second time window, after receiving the authentication request, and wherein authentication removes matching detected face images after completing an authentication request to prevent other individuals from using a same identifier;
granting access to a secured area responsive to the authentication;
determining that the master system can be reached by the first network, after performing authentication;
downloading an up-to-date copy of the authentication-list to the first worker system, from the master system, responsive to the determination that the master system can be reached;
repeating authentication using the up-to-date copy of the authentication-list at the first worker system; and
issuing an alert responsive to a determination that the repeated authentication has a different result from authentication performed using the previously stored copy of the authentication-list.

11. A system for authentication, comprising:
a first network interface, configured to communicate with a remote master system via a first network, and to determine when the remote master system is not accessible via the first network;
an authenticator configured to perform authentication on an authentication request using a previously stored copy of the authentication-list at the first worker system when the remote master system is not accessible via the first network, wherein the authentication includes facial recognition that is performed on detected face images for a first time window, before receiving the authentication request, and for a second time window, after receiving the authentication request, and wherein authentication removes matching detected face images after completing an authentication request to prevent other individuals from using a same identifier; and
an authentication console configured to grant access to a secured area responsive to the authentication.

12. The system of claim 11, wherein the authenticator is further configured to trigger the download of the previously stored copy of the authentication-list from a second worker system.

13. The system of claim 12, further comprising a second network interface, configured to communicate with the second worker system via a second network that is distinct from the first network.

14. The system of claim 13, wherein the second network is a mesh network.

15. The system of claim 11, wherein authentication comprises multiple factors, including an identification scan, facial recognition and a schedule check for a recognized individual.

16. The system of claim 15, wherein the authenticator is further configured to authenticate the identification scan using a previously stored copy of credentials.

17. The system of claim 11, wherein the first network interface is further configured to determine that the master system can be reached by the first network, after performing authentication, and to download an up-to-date copy of the authentication-list from the master system.

18. The system of claim 17, wherein the authenticator is further configured to repeat authentication using the up-to-date copy of the authentication-list at the first worker system.

19. The system of claim 18, wherein the authentication console is further configured to issue an alert responsive to a determination that the repeated authentication has a different result from authentication performed using the previously stored copy of the authentication-list.
